(19) United States
(12) Patent Application Publication
(10) Pub. No.: US 2009/0154349 A1
(43) Pub. Date: Jun. 18, 2009

(54) Method and apparatus for managing traffic flow of forwarding entries through a virtual forwarding database of a network node

(76) Inventor: Marc R. Bernard, Miramar, FL (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/001,711

(22) Filed: Dec. 12, 2007

(51) Int. Cl. H04L 12/56

(52) U.S. Cl. 370/235

(57) ABSTRACT

Disclosed herein is a method and apparatus for supporting a virtual forwarding database in response to telecommunications network service demands and standard Media Access Control learning processes to support an overall forwarding database greater than the size supported in hardware. An example embodiment of the present invention provides a possible solution or workaround for certain hardware platforms that limit the total number of forwarding entries that are currently available. This is done by creating a virtual forwarding database that may be maintained in local random access memory and not in the switch(es)/network processors' forwarding database. As such, a traffic module (e.g., application code/processor or central processing unit) may continuously update a virtual forwarding database along with a dedicated forwarding database based on the reception of external data, which includes, but is not limited to, any combination of the following: IPTV joins/leaves, new/unknown packets, and known packets.

### BACKGROUND OF THE INVENTION

Passive optical networks are currently used in telecommunications to provide network services to end users. Passive optical networks, as used in current practice, typically include a service provider network, content server network, optical line terminal, multiplexer/demultiplexer, optical network units or terminals, and end user equipment connected via interconnections by optical fiber. Implementation of currently used passive optical networks has been expensive and is widely used. Therefore, continued use of currently used passive optical networks in future network designs would be cost effective.

### SUMMARY OF THE INVENTION

The summary that follows describes some of the example embodiments included in this disclosure. The information is proffered to provide a fundamental level of comprehension of aspects of this disclosure.

An example embodiment of the present invention includes a method and apparatus for managing traffic flow through a network node comprising: a traffic module, a dedicated forwarding database, a virtual forwarding database, and at least one interface.

In an example embodiment of the present invention, the traffic module may be configured to manage locations of at least one identifier in a complementary group based on at least one parameter associated with the at least one identifier or at least one parameter associated with the traffic flow with which the at least one identifier is associated. The dedicated forwarding database may be coupled to the traffic module and configured to receive from the traffic module a maximum number of the at least one parameter associated with the identifier or associated with the traffic flow with which the at least one identifier is associated. The virtual forwarding database may be coupled to the traffic module and configured to receive from the traffic module at least one parameter associated with the identifier or associated with the traffic flow with which the identifier is associated that is more than a maximum number supported by the dedicated forwarding database. The at least one interface may be in communication with the dedicated forwarding database and the virtual forwarding database to transmit optical signals in a downstream direction to at least one end user and to receive optical signals in an upstream direction from at least one end user.

In another example embodiment, the at least one parameter associated with the identifier includes one of the following parameters: priority of channel or aging. The at least one parameter associated with traffic flow with which the identifier is associated includes one of the following parameters: bandwidth, latency, throughput per virtual forwarding database entry, jitter, number of times either the dedicated or virtual forwarding database limit is exceeded, or average number of entries over a period of time. Managing the locations of identifiers may be based on one of the following: resource availability of the forwarding databases, resources of a manager of the forwarding databases, or information received in an upstream/downstream location.

In an example embodiment, the traffic module may be a central processing unit. The central processing unit may store and process a sorting algorithm and send entries to the dedicated or virtual forwarding databases. The dedicated and virtual forwarding databases may be in communication with one another.

Another example embodiment may further include a router to store a routing table and send entries to the traffic module or to the dedicated or virtual forwarding databases.

In another example embodiment, an end user may pay a fee to receive information from a service provider network. The requested information may include the following: information about the dedicated or virtual forwarding databases, traffic flow, at least one parameter associated with the identifiers, at least one parameter associated with the traffic flow with which the identifiers are associated, or resource availability of the dedicated or virtual forwarding databases. The end user/subscriber may submit a query to the service provider network. Then, the service provider network may collect fees from the end user and provide a response. The collection of fees could include the following forms of payment: subscription fees, single usage fees, and the like.

“Identifiers” may include at least one of the following: Media Access Control (MAC) addresses of an existing device, channel containing the traffic, the traffic itself, source or destination, multicast, unicast, Internet Protocol addresses, ports, virtual local area network, and Gigabit Passive Optical Network (GPON) evaluation mode ports identifier. The interfaces may include one of the following interfaces: serial, Ethernet, wireless, fiber optic, coaxial, or universal serial bus.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A illustrates an example embodiment of the present invention that may be employed to improve an overall performance of a passive optical network (PON) by minimizing an amount of “flooding” that occurs.

FIG. 1B is more detailed view of an optical network terminal that may be utilized in an example embodiment of the present invention.

FIG. 2 is an illustration of a telecommunications device that may be used in accordance with an example embodiment of the present invention.

FIG. 3 is a flow diagram of an example method of the present invention.

FIG. 4 is a flow diagram of another example of the present invention.

### DETAILED DESCRIPTION OF THE INVENTION

A description of example embodiments of the invention follows.

Network services provided through the current use of passive optical networks include telephone, cable television, and the Internet. Each optical network unit or terminal contains a dedicated forwarding database that sends packets of network services through the network. The dedicated forwarding database has certain limitations. One limitation is the number of entries available. Once the dedicated forwarding database is full, the end user will not receive network services that are unable to be sent through the database. This may result in flooding or the dropping of packets, thereby reducing the number of end users to receive the network services.

Additionally, in current practice, source and destination addresses of traffic flow may be learned by ports (or interfaces) in a passive optical network and aged entries of the traffic flow may be removed from a forwarding database. Searches of a database containing information regarding the traffic of a network, may also be allowed. However, each of the aforementioned examples of passive optical networks as used in current practice suffers from limitations that affect the overall performance of the passive optical network. For example, once an aged entry is removed, it will have to be relearned by the network, which is time-consuming and inefficient.

In contrast, example embodiments of the present invention allow for an increased number of entries within the traffic flow of a network to be sorted, stored, and sent to/received from an end user. Example embodiments do so while reducing the likelihood of dropped entries (or packets) or flooding of packets to network interfaces as well as allowing the end user to receive desired services without noticing problems with his/her service(s) or affecting the number of potential end user(s).

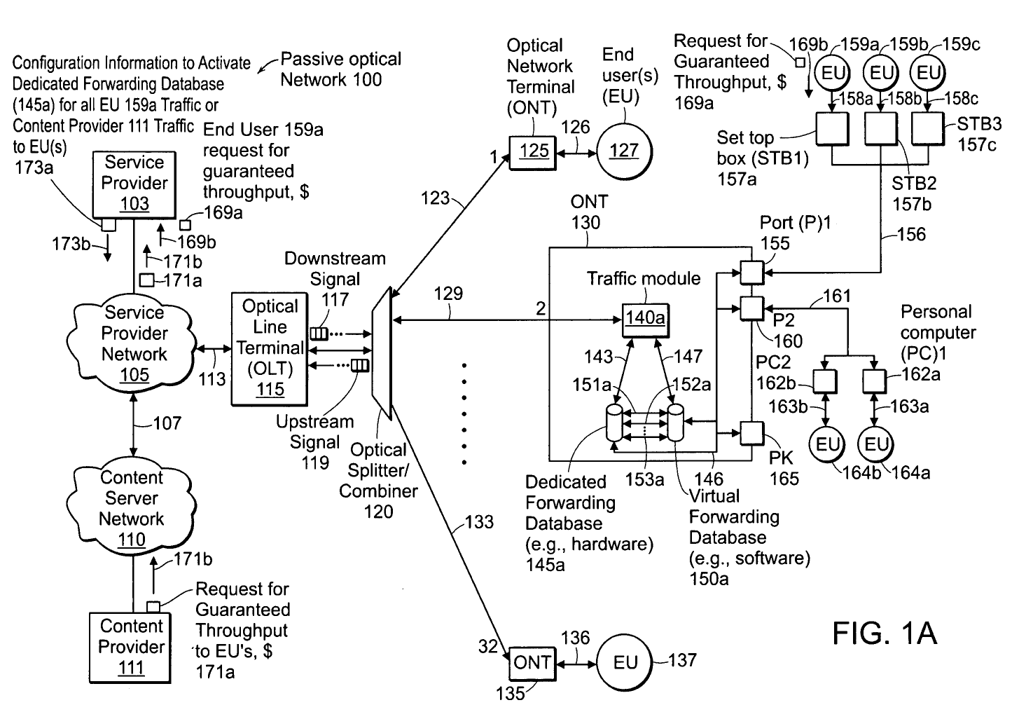

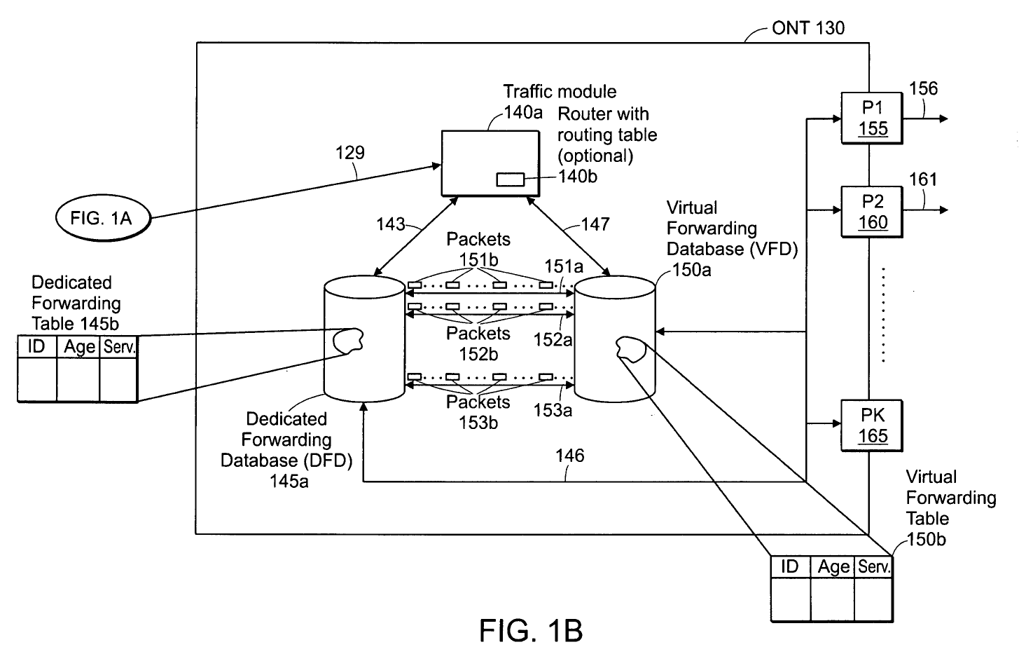

FIGS. 1A and 1B illustrate an example embodiment of the present invention that may be employed to improve overall performance of a passive optical network (PON) 100 by minimizing an amount of flooding that occurs. This may be done by minimizing the number of dropped packets 151b, 152b, 153b that occur at the data link layer (layer 2) of the Open Source Interconnection (OSI) model, which results in fewer transmission control protocol issues/hand-shaking at upper layers. The PON 100 includes a service provider network 105 in communication 107 with a content server network 110. The service provider network 105 sends and receives optical signals to and from an optical line terminal (OLT) 115 via an optical fiber 113. The OLT 115 sends a downstream signal 117 and receives upstream signals 119 via an optical combiner/splitter 120. The optical combiner/splitter 120 is in communication via optical paths 123, 129, 133 with optical network terminals (ONT) 125, 130, 135, respectively. Typically, in today's networks, an optical combiner/splitter 120 may be in communication with a maximum of thirty-two ONTs 125, 130, 135, although in the future, the number may be increased using various electrical or optical techniques known in the art. In current practice, the ONTs 125, 135 are in communication via communications paths (e.g., optical, electrical, or radio frequency) 126, 136 with end user(s) 127, 137.

An example embodiment of the present invention employs an ONT 130 that contains a traffic module 140a to manage locations of at least one identifier in a complementary group of dedicated (145a) or virtual (150a) forwarding databases based on at least one parameter associated with the identifier or at least one parameter associated with the traffic flow with which the identifier is associated. The traffic module 140a is in communication 143, 147 with the dedicated forwarding database 145a and the virtual forwarding database 150a. The dedicated forwarding database 145a and the virtual forwarding database 150a may be in communication 151a, 152a, 153a with one another as well. For example, the traffic module 140a may send to the dedicated forwarding database 145a a maximum number of entries associated with an identifier or associated with the traffic flow with which the identifier is associated. The traffic module 140a may send to the virtual forwarding database 150a at least one entry with an identifier or associated with the traffic flow with which the identifier is associated that is more than the maximum number of entries supported by the dedicated forwarding database 145a. The entries are stored in either the dedicated forwarding table 145b of the dedicated forwarding database 145a or the virtual forwarding table 150b of the virtual forwarding database 150a. The dedicated forwarding table 145b, virtual forwarding table 150b, and routing table may store information that identifies an entry/packet, such information may include, but is not limited to, the following: identifier (ID), age, service (Serv.), location, user activity, event(s).

The ONT 130 may also employ at least one interface (represented as ports (P), e.g., P1 155, P2 160, and PK 165) that is in communication with the dedicated forwarding database 145a (via optical fiber 146) or virtual forwarding database 150a (via optical fiber 154) to transmit optical signals representing an entry in a downstream direction and to receive optical signals in an upstream direction from at least one end user. Each port may be in communication with an end user via a variety of communication techniques, e.g., set-top boxes (STB) or a personal computer (PC). For example, an interface (P1 155) may be in communication 156 with several STBs and end users, such as STB1 157a in communication 158a with an end user 159a, STB2 157b in communication 158b with an end user 159b, and STB3 157c which is in communication 158c with an end user 159c. An interface (P2 160) may also be in communication 161 with several PCs and end users, such as PC1 162a in communication 163a with end user 164a and PC2 162b in communication 163b with end user 164b.

Ultimately, a PON 100 in accordance with an example embodiment of the present invention is able to support a much larger number of end users 159a, 159b, 159c, 164a, 164b that require entries in the ONT's 130 dedicated forwarding database 145a. This is particularly useful for situations in which Internet Protocol Television (IPTV) services begin competing for entries in the dedicated forwarding database 145a. All IPTV streams that are being “watched” or requested by users are maintained. IPTV is a service that provides digital television via means typically associated with computer network technology. For example, IPTV employs real-time data transmission and data-oriented protocol for a network that communicates via packets. As such, if a packet is lost, delays may occur that may reduce connection speed, quality of image displayed, or unreliable data in the packets. A packet may be lost if packets are flooded into the PON 100. The problem of flooding is greatly reduced by employing an example embodiment of the present invention because the addition of a virtual forwarding database 150a allows for the sorting, storing, and retrieval of a larger number of packets.

An example embodiment of the present invention maintains all desired Media Access Control (MAC) addresses in memory and continues aging as needed. Example embodiments of the present invention have several purposes, such as ensuring that the most active MAC entries are always in the dedicated forwarding database 145a. Another example embodiment ensures that only the oldest entries are moved to a virtual forwarding database 150a when there is a need to learn new MAC addresses or alternatively when there is a need to add a forwarding entry associated with IPTV channels. This ensures that IPTV entries remain in a dedicated (e.g., hardware) forwarding database 145a, whereas other entries may be moved between the dedicated forwarding database 145a and the virtual (e.g., software) forwarding database 150a based on user activity (e.g., IPTV activity, existing user activity, new user discovery, etc.). An example embodiment of the present invention ensures that all IPTV MAC entries remain in the hardware forwarding database 145a until the end user (e.g., end user 159a) requests that the entry be removed via a command or through standard clean-up messages. This potentially minimizes the processing by the central processing unit (CPU) for constantly handling large bursts of data that do not exist already in the hardware forwarding database 145a.

Another example embodiment of the present invention installs a software assist utility on the traffic module 140a to allow an existing device 130 (e.g., optical network terminal (ONT), cable modem, etc.) to be able to increase the total number of entries that can be globally supported within the device 130. In this case, from a black-box approach, the external users 159a, 159b, 159c may not be aware that there is only a small dedicated forwarding database 145a with the rest of the entries maintained in a software forwarding database 150a. Entries in the dedicated forwarding database 145a and the virtual forwarding database 150a may be moved from location to location based on different events occurring, e.g., if the dedicated forwarding database 145a only supports a maximum number of entries (MAX1) for IPTV and MAC forwarding entries. Other events that may occur to require moving entries from location to location include, but are not limited to, aging or space becoming available in the dedicated forwarding database 145a. There may be applications where the device 130 (e.g., ONT, cable modem, etc.) is needed to support a larger number (MAX2) of entries (i.e., MAX2 greater than MAX1). However, a current problem for networks is that the dedicated forwarding database 145a is limited to only allow MAX1 entries. This example embodiment resolves this problem by increasing the number of entries that are maintained by the dedicated forwarding database 145a because of the additional entries that may be maintained in the virtual forwarding database 150a.

In another example embodiment of the present invention, the virtual forwarding database is implemented for buffer purposes. Service providers 105 or end users 159a, 159b, 159c may want to know if the dedicated forwarding database 145a has been surpassed. As such, the ONT 130 may declare an alarm/event/notification/warning to the service provider 105, end user 159a, 159b, 159c, or the like when the dedicated forwarding database 145a has been surpassed, or perhaps when the entire virtual forwarding database 150a size has been surpassed, or both. The collected information may be used to determine if the value for MAX2 should be increased (e.g., if the performance of the ONT 130 proves to be able to support such an increase), decreased (e.g., if the performance of the ONT 130 proves to not be able to support such an increase), or other. An example of the ONT 130 not performing very well is if an end user 159a receives bad voice performance, dropped data, bad video, reboots, etc., which may be due to the implementation of a virtual forwarding database 150a on the ONT 130. As such, if the service provider 105 is able to identify and correlate the above performance monitor parameters or alarms with other misbehavior in the ONT 130, then the service provider 105 may relax some of the parameters for the virtual forwarding database 150a (or vice-versa).

Another example embodiment of the present invention allows a third party (e.g., 159a or content provider 111) to submit a request to the service provider 103. For example, an end user (or subscriber) 159a may submit a request 169a to the service provider 103 for an adjustment to the services the end user 159a receives. The service provider 103 may receive a signal 169b from the end user 159a that includes a request 169a for guaranteed throughput. The service provider 103 may collect fees (represented in FIG. 1A as “$”) and, upon receipt of said fees, provide a response 173a to the end user's request 169a. The response 173a of the service provider 103 may include configuration information to activate the dedicated forwarding database 145a to guarantee throughput to the end user 159a. The content provider 111 may also request 171a that the service provider 103 provide guaranteed throughput to a particular end user 159a. The content provider 111 may send a signal 171b, which includes the request 171a, to the service provider 103. The service provider 103 may collect fees from the content provider 111 and send a signal 173b to the dedicated forward database 145a with the necessary configuration information 173a.

The requests 169a, 171a may be for services or information. The end user 159a or content provider 111 may request services, such as guaranteed throughput, maintenance of services in the dedicated (145a) or virtual (150a) forwarding databases, or assurance of the rate or quality of services. A request for information may include, but is not limited to, the following: information about the (i) dedicated (145a) or virtual (150a) forwarding databases, (ii) traffic flow, (iii) at least one parameter associated with the identifiers, (iv) at least one parameter associated with the traffic flow with which the identifiers are associated, or (v) resource availability of the dedicated (145a) or virtual (150a) forwarding databases. The collection of fees may include the following forms of payment: subscription fees, single usage fees, and the like. The use of end user 159a and content provider 111 is for exemplary purposes only and not to limit the type of third party that may be allowed to submit a request in accordance with this example embodiment.

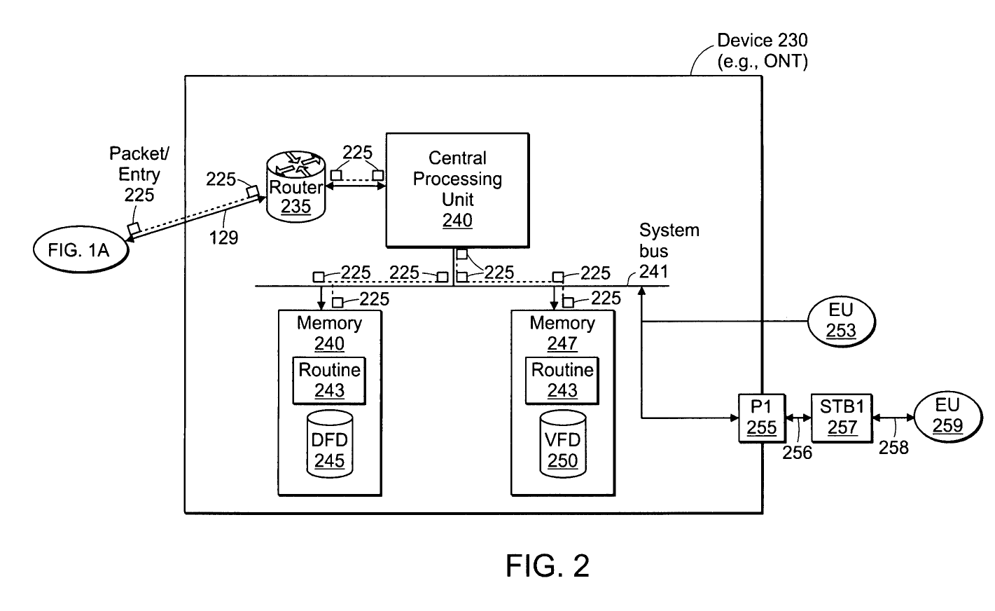

FIG. 2 illustrates a telecommunications device (device) 230 that may be used in accordance with an example embodiment of the present invention. A virtual forwarding database 250 may be utilized to increase the total number of MAC entries that the device 230 “seemingly” supports to an end user 253 or group of end users 259, where “seemingly” means that end user(s) 253, 259 are unaware of internal processes used to maintain entries in the dedicated and virtual forwarding databases 245, 250. The virtual forwarding database 250 may be managed by a traffic module, such as a central processing unit (CPU) 240, to allow for a larger number of overall entries to be distributed. In essence, the virtual forwarding database 250 may support at least the difference between the larger number of MAC entries and the number of MAC entries that may be supported by the device 230 number of entries (MAX3=MAX2−MAX1). The new value may or may not be configurable by the service provider.

Current practice is based on the IEEE 802.1D standard. As the device 230 learns new MAC addresses, those packets 225 are forwarded by a router 235 that may contain a routing table (not shown) to a CPU 240, and the CPU 240 then adds entries in the dedicated forwarding database 245. The routing table may be used to sort and send the packets 225 to the CPU 240. The CPU 240 may itself store and employ a storing algorithm to sort and direct packets 225 to the dedicated forwarding database 245 or virtual forwarding database 250. In a bridging environment, all future packets may have been learned, so the next time the device 230 receives those “learned” packets 225, the hardware forwarding database 245 forwards those packets 225 instead of re-sending them to the CPU 240. As more and more packets 225 are learned, the dedicated forwarding database 245 fills up. The dedicated forwarding database 245 entries may include the following example entries:
Learned MAC devices from equipment (e.g., personal computers (PCs), routers, set-top boxes (STBs), wi-fi devices, femtocell devices, picocell devices, wireless devices, etc.) connected on the local area network (LAN) interface of the device (e.g., ONT 230)
IPTV streams that an end user 253 in the home is watching. IPTV streams may preferably be added to the hardware forwarding database 245 because the device 230 continuously sends these channel streams (represented as channel streams in a downstream direction 146, 154 in FIG. 1A) towards an end user 253 interface in the home/business/etc. on the LAN side (represented as STBs 157a, 157b, 157c in FIG. 1A). Each channel that an end user 253 is watching has an entry in the dedicated forwarding database 245. When the end user 253 in the home stops viewing the channel, the STB (or similar PC or other IPTV capable device) sends a ‘leave’ message to the device 230, and the device 230 then removes the IPTV MAC entry from the dedicated forwarding database 245.
Other special packets that the device 230 may be configured to detect based on the packet content (e.g., EtherType, IP Address, virtual local area network (VLAN) identification, p-bits, etc.).

Once the dedicated forwarding database 245 fills up and unknown packets 223 are received, the unknown packets 225 are also forwarded by the router 235 to the CPU 240, and instead of dropping unknown packets 225 (or immediately adding unknown packets 225 to the dedicated forwarding database 245, which is already full), an example embodiment of the present invention does the following. First, the CPU 240 receives these “new” packets, which may be added to the dedicated forwarding database 245 as shown below:
Instead of dropping the packet(s) 225, the CPU 240 performs regular bridging operations with this packet 225 (e.g., flooding all upstream ports) and may further do the following actions:
The CPU 240 may examine all existing MAX1 entries in the dedicated forwarding database 245 and take the oldest entry, call it entry OLD1 (based on aging), move it (along with its aging information and any other applicable information) to a local virtual forwarding database 250 in memory 247, such as random access memory, and replace this OLD1 entry in the dedicated forwarding database 245 with the new learned packet information.
Aging continues for this OLD1 entry, but continues while the entry is in the virtual forwarding database 250 in memory 247 and not in the dedicated forwarding database 245.

Then, if the aging expires, the OLD1 entry is removed from the virtual forwarding database 250. If packets 225 associated with this OLD1 entry are received, for example, on an ONT's Ethernet interface, then the packets 225 are sent by the router 235 to the CPU 240 instead of automatically being forwarded as if they were already in the dedicated forwarding database 245. The CPU detects that these packets are associated with this OLD1 entry located in the virtual forwarding database 250 in memory 247, so it does not flood all interfaces (i.e., flooding typically only occurs if the received packets are new/unknown MAC addresses), but, instead, the OLD1 entry is re-sent to the dedicated forwarding database 245 by replacing the now oldest entry (OLD2) detected in the dedicated forwarding database 245. The OLD2 entry (i.e., aging information, etc.) is moved to the local virtual forwarding database 250 in memory 247 for further aging/processing.

The process outlined above allows the most active MAC addresses to stay in the dedicated forwarding database 245 and allows the CPU 240 to temporarily handle some of the old traffic that is not currently in the dedicated forwarding database 245, but is still in the virtual forwarding database 250 in memory 247. The end user 253 only sees that the device 230 can support the MAX2 entries, as expected.

Another example embodiment of the present invention allows the dedicated forwarding database to be updated based on learned MAC addresses as well as IPTV ‘join’ or ‘leave’ messages. For example, when IPTV channel streams are requested from end users 259, the dedicated forwarding database 245 expects additional entries for each channel. When the dedicated forwarding database 245 fills up, the dedicated forwarding database 245 is updated with each additional channel requested. Simultaneously, the CPU 240 moves an entry from the dedicated forwarding database 245 to the virtual forwarding database 250 using the process described above. IPTV entries may not be moved to the virtual forwarding database 250. However, when IPTV streams are removed (e.g., using leave messages) from the dedicated forwarding database 245 without being replaced (i.e., the user shuts down the television or stops simultaneously streaming a large number of channels), then MAC addresses are re-directed to the virtual forwarding database 250 to minimize CPU 240 intervention. Similarly, when MAC entries expire from the dedicated forwarding database 245, then this may be a trigger (or signal) to the CPU 240 that entries from the virtual forwarding database 250 are typically (or automatically) moved from the virtual forwarding database 250 to the dedicated forwarding database 245. Another example embodiment of the present invention includes other “special” types of high priority entries that are not moved to the virtual forwarding database 250 due to possible latency issues or performance issues that might be associated with some switches/network processors that perform this operation.

Possible problems may occur when the device 230 must simultaneously process large amounts of traffic flow from end user devices (e.g., STB1 257) in which the MAC address is in the virtual forwarding database 250. In these situations, an example embodiment of the present invention further accommodates when certain entries may have larger throughput requirements than others (for example, some end users may download large files or view video, whereas other active end users are viewing webpages). In these scenarios, there is a preference for the CPU 240 to process MAC entries of end users 259 viewing web pages and then add the MAC entries associated with the higher-throughput applications in the dedicated forwarding database 245 so there are no future CPU 240 implications. Thus, the characteristics of the applications associated with MAC entries ultimately determines if the entries are maintained in the dedicated forwarding database 245 or in the virtual forwarding database 250.

Another example embodiment allows for situations in which the device 230 is simultaneously processing entries (E1), where E1 is greater than MAX1. In this case, the CPU 240 must process traffic. When this occurs, it is expected that the CPU 240 is capable of handling a predetermined amount of traffic. When this occurs, the CPU 240 may further start looking at entry-user-content characteristics, such as throughput (or other important possible characteristics, such as latency, or if the MAC entry was configured by the end user 259 or the service provider to be a “special” dedicated forwarding database 245 permanent entry). At this point, the entry can be swapped with another lower impact entry (e.g., lower throughput or other lower processing intensive characteristics) located in the dedicated forwarding database 245.

Another example embodiment of the present invention includes a CPU 240 processing high bandwidth applications that are very processor intensive. When this occurs, it is useful to have a product that has architected support user services under pre-determined assumptions. It is expected that the number of MAX2 entries are pre-determined based on processor capacity, and other applications that the device performs may also be taken in consideration. For example, the CPU 240 may also be performing Session Initiation Protocol (SIP) applications that take up a certain amount of instructions per second because such applications are also highly processor intensive.

When both the dedicated forwarding database 245 and the virtual forwarding database 250 are full with MAC entries, if additional MAC entries are learned, an example embodiment of the present invention covers the case in which the CPU 240 is either capable of looking for the oldest entry in both the dedicated forwarding database 245 and the virtual forwarding database 250 (or similar), or the case in which once the forwarding databases 245, 250 are full, then any new entries cannot be added until entries have been aged/expired and removed from either forwarding database 245, 250.

In another example embodiment of the present invention, an end user 253 may configure entries in the dedicated forwarding database 245, as defined in the IEEE 802.1D standard. When this occurs, the same scenarios as above are taken into consideration. That is, a new static entry can either be permanently placed in the dedicated forwarding database 245 or placed in either the dedicated forwarding database 245 or virtual forwarding database 250. When this occurs, permanent entries may still have an internal “aging” parameter that can be used internally by the device 230 to determine if the entry can be moved from the dedicated forwarding database 245 to the virtual forwarding database 250 based on any activity detected on this permanent entry during a certain amount of time.

In another example embodiment of the present invention, a static entry may be in the dedicated forwarding database or even permanently in the virtual forwarding database 250 based on the end user's 253 known understanding of the expected content's characteristics for this entry. For example, if the entry is associated with high-throughput needs, the end user 253 may want to ensure that the entry is always in the dedicated forwarding database 245. If the entry is always used for web-page viewing, the end user 253 may also allow the entry to always be in the virtual forwarding database 250. Alternatively, there can be an option to allow an entry to be moved back and forth based on normal treatment (as defined herein) for MAC entries.

Another example embodiment of the present invention includes performance monitoring that may be collected for this type of implementation to be able to troubleshoot the device 230 with such an implementation or simply better know the overall system performance of such a device 230. For example, performance monitoring parameters can be collected for:
Number of times dedicated forwarding database 245 (DFD) limit surpassed.
Number of times virtual forwarding database 250 (VFD) limit reaches
Average number of virtual forwarding database entries during certain amount of time.
Average throughput per virtual forwarding database entry during a certain amount of time.

One with skill in the art knows that the CPU 240 is capable of supporting a certain amount of throughput processing without rebooting or impacting existing data. The features defined in an example embodiment of the present invention are not intended for all hardware, since some processors cannot support the additional processing/steps/data manipulation as described herein. However, there are cases where there are sophisticated processors/CPUs 240, but the dedicated forwarding database 245 does not provide sufficient entries for different applications that require a large number of entries.

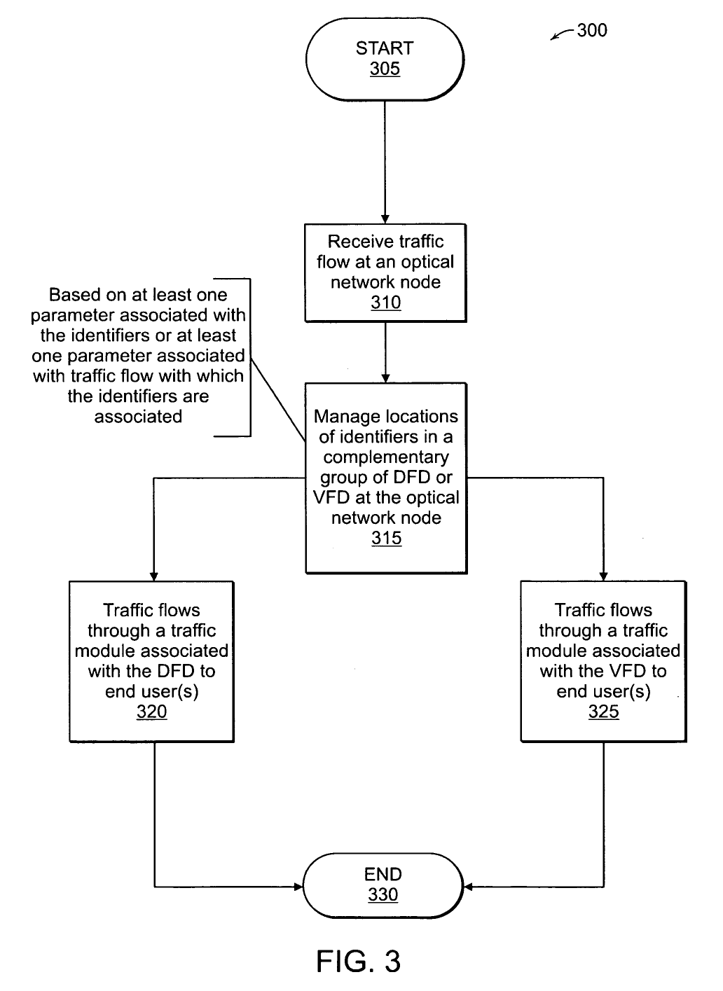

FIG. 3 is a flow diagram 300 of an example method of the present invention that begins 305 with traffic flow being received 310 at an optical network node. Then, the locations of identifiers are managed 315 in a complementary group of dedicated or virtual forwarding databases at the optical network node. This is based on at least one parameter associated with the identifiers or at least one parameter associated with traffic flow with which the identifiers are associated. Next, the traffic associated with the identifier is allowed to flow through traffic modules associated with the dedicated forwarding database 320 and the virtual forwarding database 325, which directs the traffic flow through the optical network node to at least one end user. The at least one parameter associated with the identifiers includes either priority of a channel or aging of an entry in the traffic flow. The at least one parameter associated with traffic with which the identifiers are associated includes at least one of the following: bandwidth, latency, throughput per virtual forwarding database entry, jitter, number of times either the dedicated or virtual forwarding database limit is exceeded, or average number of entries over a period of time. Managing the locations of identifiers may be based on resource availability of the forwarding databases (e.g., dedicated forwarding table 145b or virtual forwarding table 150b as shown in FIG. 1B). Managing the locations of identifiers may also be based on information received in an upstream/downstream direction. Managing the locations of identifiers may be based on resources of a manager (e.g., router with routing table 140b as shown in FIG. 1B) of the forwarding databases. Resources of the manager may also include a learned entry, sorting algorithm or user input. As used herein, “identifiers” may include at least one of the following: Media Access Control (MAC) addresses of an existing device, channel containing the traffic, the traffic itself, source or destination, multicast, unicast, Internet Protocol (IP) addresses, ports, virtual local area network (VLAN), and Gigabit Passive Optical Network (GPON) evaluation mode (GEM) ports identifier.

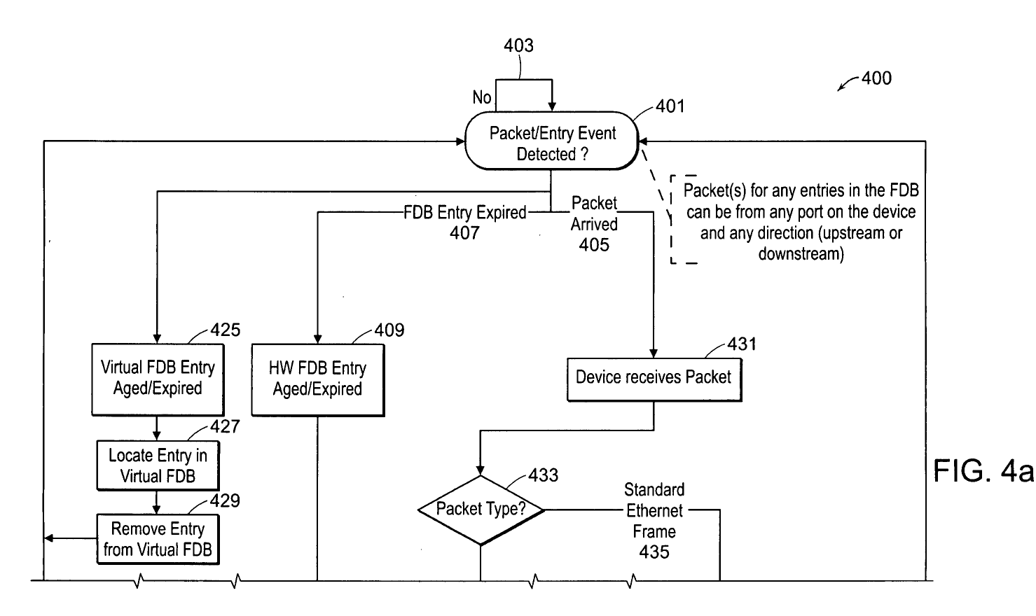

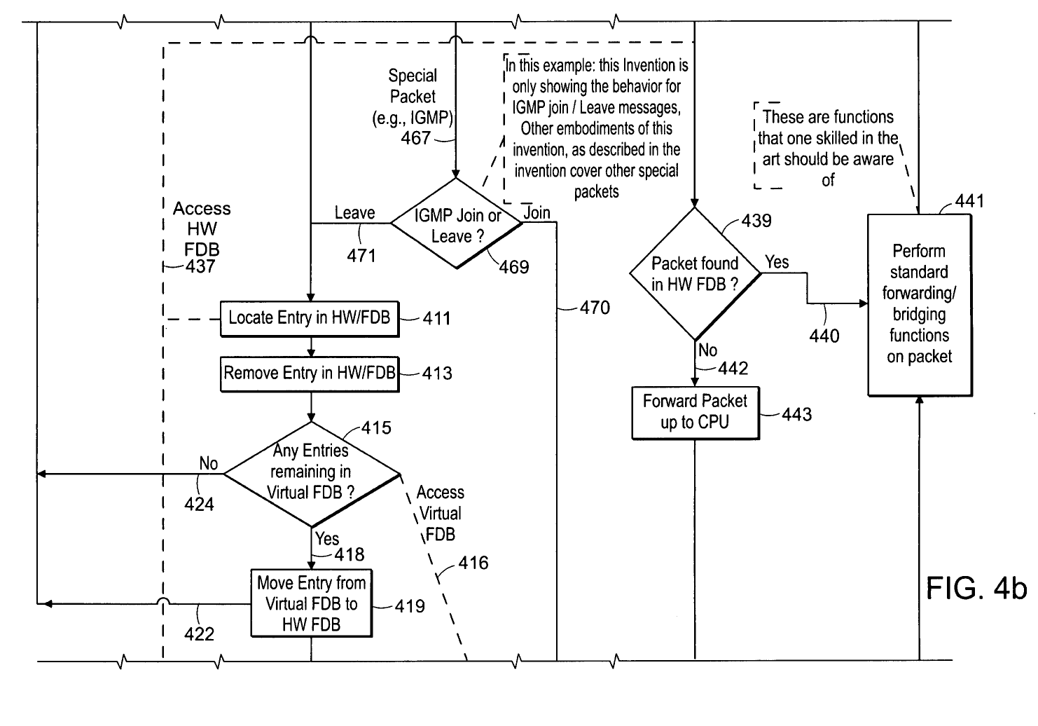

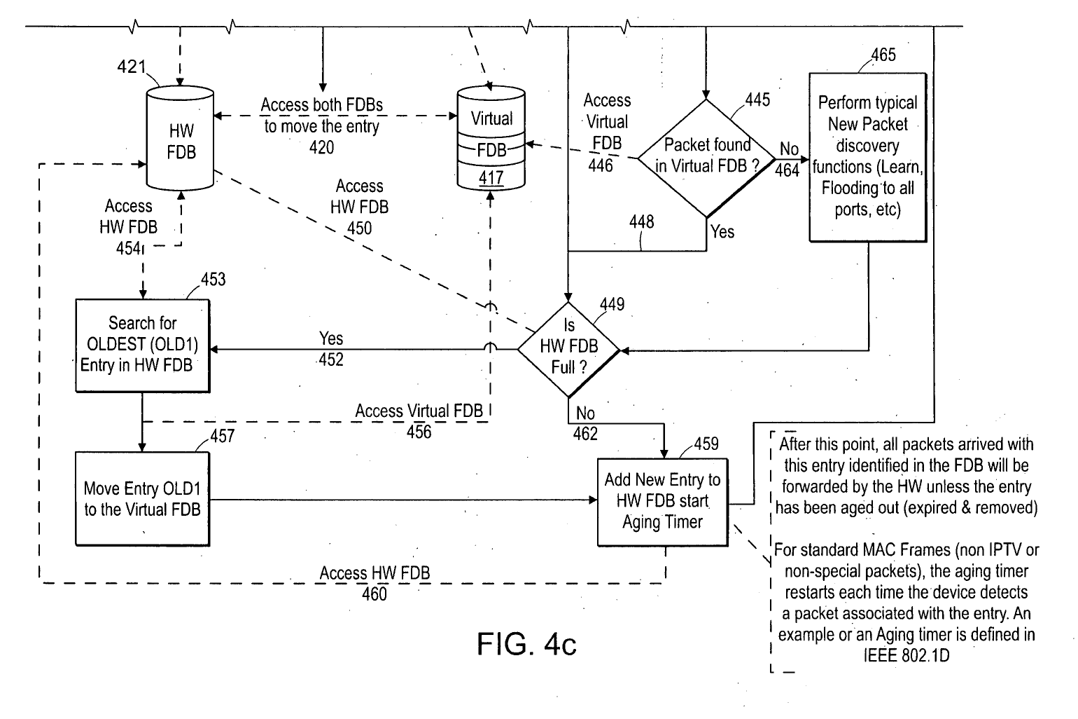

FIG. 4 is a flow diagram 400 of an example method of the present invention. The process begins by detecting 401 if a packet (or entry) event has occurred. If a packet event has not occurred 403, the process remains idle. Once a packet has been detected, the packet either arrives 405 to the device or the forwarding database (FDB) entry expires 407.

If the FDB entry expires 407, it may be because the hardware (HW) FDB entry has aged/expired 409. If so, the entry may be located 411 in the HW FDB 421. Then, the entry may be removed 413. Next, the method may inspect 415 the virtual FDB 417 for any remaining entries by accessing 416 the virtual FDB 417. If there are any remaining entries 418 in the virtual FDB 417, the entry may be moved 419 from the virtual FDB 417 to the HW FDB 421. This may be done by accessing 420 both FDBs (virtual 417 and HW 421). After the entry is moved 419 or if there are no remaining entries 424, the method will wait to detect 401 another packet event. Alternatively, if the FDB entry expires 407, it may be because the virtual FDB entry has aged/expired 425. If so, the entry may be located 427 in the virtual FDB 417 and then removed 429. After the entry has been removed 429, the method will wait to detect 401 another packet event.

After the packet arrives 405, the device (e.g., hardware switch) may receive 431 the packet and then recognize 433 the packet type. The packet may either be a standard Ethernet frame 435 or a special packet 467 (e.g., Internet Group Management Protocol (IGMP)). For a standard Ethernet frame 435, the device may access 437 the HW FDB 421. The device may register that a packet is found 439 in the HW FDB 421. If a packet is found 440, the device will perform 441 standard forwarding/bridging functions on the packet and then detect 401 if another packet event has occurred. If a packet was not found 442 in the HW FDB 421, the packet will be forwarded 443 to a CPU. Then, the virtual FDB may be inspected 445. The virtual FDB 417 may be accessed 446. If a packet is found 448, the HW FDB 421 may be inspected 449 by accessing 450 the HW FDB 421. If the HW FDB 421 is full 452, then the HW FDB 421 may be accessed 454 to search 453 for the oldest (OLD1) entry in the HW FDB 421. Then, the virtual FDB 417 may be accessed 456 and OLD1 may be moved 457 to the virtual FDB 417. Next, the new entry may be added 459 to the HW FDB 421 and the aging timer may be started by accessing 460 the HW FDB 421. If the HW FDB 421 is not full 462, the new entry may be added 459 to the HW FDB 421 and the aging timer may be started. If a packet is not found 464 in the virtual FDB 417, the device will perform 465 a new packet discovery function (e.g., learn, flooding to all ports, etc.).

Please note that while this example method only illustrates the behavior for a special packet 467 using join 470 or leave 471 messages, other example embodiments of the present invention include for other special packets 467.

The special packet 467 may include 469 either a join 470 or leave 470 message. If the special packet 467 includes a join message 470, the HW FDB 421 may be inspected 449. If the HW FDB 421 is not full 462, a new entry may be added 459 to the HW FDB 421 and an aging timer may be initiated as well as the HW FDB 421 may be accessed 460. At this point, all packets that arrived with the entry may be identified in the FDB and forwarded by the HW, unless the entry has been aged out (e.g., expired or removed). For example, for a standard MAC frame (meaning, non-IPTV or non-special packets), the aging timer restarts (or reinitiates) each time the device detects a packet associated with the entry. An example of an aging timer is defined in the IEEE 802.1D standard.

If the special packet 467 has a leave message 471, an entry in the HW FDB 421 may be located 411 and said entry may be removed 413. Then, the virtual FDB 417 may be checked 415 for any remaining entries. The virtual FDB 417 may be accessed 416. If there are any entries remaining 418 in the virtual FDB 417, the entry may be moved 419 from the virtual FDB 417 to the HW FDB 421, which may be done by accessing 420 both the virtual FDB 417 and the HW FDB 421. After the entry has been moved 419 and if there are no remaining entries 424 in the virtual FDB 417, the method will detect 401 if a new packet event has occurred.

While this invention has been particularly shown and described with references to example embodiments thereof, it will be understood by those skilled in the art that various changes in form and details may be made therein without departing from the scope of the invention encompassed by the appended claims.

Even though passive optical networks have been shown and described herein, it should be understood by one with ordinary skill in the art that additional embodiments are available. For example, a network in accordance with an example embodiment of the present invention may include, but is not limited to, one of the following: passive optical, active optical, non-optical, or wireless.

It should also be understood that the flow diagrams of FIGS. 3 and 4 are examples that may include more or fewer components, be partitioned into subunits, or be implemented in different combinations. Moreover, the flow diagrams may be implemented in hardware, firmware, or software. If implemented in software, the software may be written in any software language suitable for use in networks as illustrated in FIGS. 1A, 1B, and 2. The software may be embodied on any form of computer readable medium, such as RAM, ROM, or magnetic or optical disk, and loaded and executed by generic or custom processor(s).

What is claimed is:

1. A method of managing traffic flow through a network node, comprising:
managing locations of identifiers in a complementary group of dedicated or virtual forwarding databases at the network node based on at least one parameter associated with the identifiers or at least one parameter associated with traffic flow with which the identifiers are associated; and
causing the traffic flow associated with the identifiers to flow through traffic modules associated with the dedicated or virtual forwarding databases to manage the traffic flow through the network node to at least one end user.

2. The method as claimed in claim 1 wherein the at least one parameter associated with the identifiers includes at least one of the following parameters: priority of channel or aging.

3. The method as claimed in claim 1 wherein the at least one parameter associated with the traffic flow with which the identifiers are associated includes at least one of the following parameters: bandwidth, latency, throughput per virtual forwarding database entry, jitter, number of times either the dedicated or virtual forwarding database limit is exceeded, or average number of entries over a period of time.

4. The method as claimed in claim 1 wherein managing the locations of identifiers is based on resource availability of the dedicated or virtual forwarding databases.

5. The method as claimed in claim 1 wherein managing the locations of identifiers is based on information received in an upstream direction.

6. The method as claimed in claim 1 wherein managing the locations of identifiers is based on information received in a downstream direction.

7. The method as claimed in claim 1 wherein managing the locations of identifiers is based on resources of a manager of the forwarding databases.

8. The method as claimed in claim 7 wherein the resources of the manager include at least one of the following: a routing table, learned entry table, sorting algorithm or user input.

9. The method as claimed in claim 1 wherein the identifiers include at least one of the following: Media Access Control (MAC) addresses of an existing device, channel containing the traffic flow, the traffic flow, source or destination, multicast entries, unicast entries, Internet Protocol (IP) addresses, ports, virtual local area network (VLAN), and gigabit passive optical network (GPON) evaluation mode (GEM) ports identifier.

10. The method as claimed in claim 1 wherein the network node is a passive optical network node.

11. The method as claimed in claim 1 further including responding to a request from a third party.

12. The method as claimed in claim 11 wherein the request is about the dedicated or virtual forwarding databases, traffic flow, at least one parameter associated with the identifiers, at least one parameter associated with the traffic flow with which the identifiers are associated, or resource availability of the dedicated or virtual forwarding databases.

13. The method as claimed in claim 11 further including collecting fees from the third party to provide a response to the request.

14. The method as claimed in claim 13 wherein collecting fees includes collecting fees in the form of subscription fees.

15. An apparatus to manage traffic flow through a network node, comprising:
a traffic module configured to manage locations of at least one identifier in a complementary group of dedicated or virtual forwarding databases based on at least one parameter associated with the identifiers or at least one parameter associated with the traffic flow with which the identifiers are associated;
a dedicated forwarding database coupled to the traffic module and configured to receive from the traffic module a maximum number of entries associated with the identifiers or associated with the traffic flow with which the identifiers are associated;
a virtual forwarding database coupled to the traffic module and configured to receive from the traffic module at least one entry with the identifiers or associated with the traffic flow with which the identifiers are associated that is more than the maximum number of entries supported by the dedicated forwarding database; and
at least one interface coupled to the dedicated forwarding database or virtual forwarding database to transmit signals representing an entry in a downstream direction to at least one end user and to receive signals in an upstream direction from at least one end user.

16. The apparatus as claimed in claim 15 wherein the at least one parameter associated with the identifiers includes at least one of the following parameters:
priority of channel or aging.

17. The apparatus as claimed in claim 15 wherein the at least one parameter associated with traffic flow with which the identifiers are associated includes at least one of the following parameters: bandwidth, latency, throughput per virtual forwarding database entry, jitter, number of times either the dedicated or virtual forwarding database limit is exceeded, or average number of entries over a period of time.

18. The apparatus as claimed in claim 15 wherein the traffic module is further configured to manage locations of identifiers based on resource availability of the dedicated or virtual forwarding databases.

19. The apparatus as claimed in claim 15 wherein the traffic module is further configured to manage locations based on resources of a manager of the dedicated or virtual forwarding databases.

20. The apparatus as claimed in claim 15 wherein the traffic module is configured to manage locations based on information received in an upstream location.

21. The apparatus as claimed in claim 15 wherein the traffic module is configured to manage locations based on information received in a downstream location.

22. The apparatus as claimed in claim 15 wherein the traffic module is a central processing unit (CPU).

23. The apparatus as claimed in claim 22 wherein the CPU is configured to store and process a sorting algorithm and to send entries to the dedicated or virtual forwarding databases.

24. The apparatus as claimed in claim 15 further including a router configured to store a routing table and to send entries to the traffic module or to the dedicated or virtual forwarding database.

25. The apparatus as claimed in claim 15 wherein the traffic module is configured to store a learned entry table, sorting algorithm, or user input.

26. The apparatus as claimed in claim 15 wherein the identifiers include at least one of the following: Media Access Control (MAC) addresses of an existing device, channel containing the traffic flow, the traffic flow, source or destination, multicast entries, unicast entries, Internet Protocol (IP) addresses, ports, virtual local area network (VLAN), and gigabit passive optical network (GPON) evaluation mode (GEM) ports identifier.

27. The apparatus as claimed in claim 15 wherein the dedicated forwarding database and the virtual forwarding database are coupled to one another.

28. The apparatus as claimed in claim 15 wherein the at least one interface includes one of the following interfaces: serial, Ethernet, wireless, fiber optic, coaxial, or universal serial bus.

29. The apparatus as claimed in claim 15 wherein the at least one interface is configured to transmit and receive optical signals.
